(19) United States
(12) Patent Application Publication
(10) Pub. No.: US 2015/0326495 A1
(43) Pub. Date: Nov. 12, 2015

(54) SYSTEM CONSTRUCTION DEVICE AND SYSTEM CONSTRUCTION METHOD

(71) Applicant: NEC CORPORATION, Minato-ku, Tokyo (JP)

(72) Inventor: Hisashi Shimamura, Tokyo (JP)

(21) Appl. No.: 14/652,169

(22) PCT Filed: Dec. 6, 2013
(86) PCT No.: PCT/JP2013/007195

§ 371 Date: Jun. 15, 2015

(30) Foreign Application Priority Data
Dec. 14, 2012 (JP) 2012-273775

(51) Int. Cl. H04L 12/911; H04L 12/26

(52) U.S. Cl. CPC H04L 47/783; H04L 43/04

(57) ABSTRACT

A system construction device that efficiently constructs a system in which dedicated servers and virtual servers are mixed is provided. An allocation unit (150) allocates, to a server to be deployed as a dedicated server among one or more servers included in a system, a processing device (200) having a resource matching a resource condition of the server to be deployed as a dedicated server among one or more processing devices (200), and allocates, to a server not to be deployed as a dedicated server, a resource matching the resource condition of the server not to be deployed as a dedicated server and being on a processing device (200) not allocated to the server to be deployed as a dedicated server among the one or more processing devices (200), as a resource for deploying the server as a virtual server, referring to system configuration information (501) and resource information (601).

### TECHNICAL FIELD

The present invention relates to a system construction device and a system construction method.

### BACKGROUND ART

With the development of server virtualization technology in recent years, a large number of IT (Information Technology) systems such as corporate business systems for customer management or salary management, systems providing Web stores for general consumers, systems providing SNS (Social Networking Service), and the like have been constructed using virtual servers in cloud environments. In a cloud environment, a large number of virtual servers are accommodated on a large number of bare metal servers using middleware referred to as a virtualization platform.

Many IT systems (hereinafter, referred to simply as systems) include not a single server but a large number of servers to allocate a server for each functional component or to perform distributed processing of a heavy load using a plurality of servers. For example, PTL 1 discloses a technique for efficiently constructing a system including a large number of servers on a virtualization platform as described above. The technique disclosed in PTL 1 efficiently accommodates virtual servers by determining a computer on which each server is disposed based on status of free resources.

On the other hand, depending on the system requirements, it is necessary to construct and operate a system not on a virtualization platform in an environment shared with other people as in the above-described cloud environment but in an environment possessed and managed by an owner (on-premises environment). This is a case in which, for example, a system handles sensitive information prohibited from being taken out, system processing performed in an environment shared with other people is prohibited under a law, or a system needs a special operation or support in view of a function and performance thereof.

For example, NPL 1 discloses an appliance product which efficiently constructs a virtualization platform equivalent to a general cloud environment on an on-premises environment. The appliance product of NPL 1 forms a vertical integration from hardware to applications of a system.

As a related technique, PTL 2 discloses a technique for determining whether a plurality of virtual servers are disposed in the same physical resource or in different physical resources in accordance with a group condition. PTL 3 discloses a technique for determining a physical resource where a virtual machine is disposed based on a priority of the physical resource, a constraint condition, and load information of the virtual machine. PTL 4 discloses a technique for adjusting a resource to be allocated to a virtual machine in accordance with a priority of an application in the virtual machine. PTL 5 discloses a resource allocation device to integrate m server devices into n (n<m) server devices. PTL 6 discloses a technique for adjusting the number of resources to be allocated to a service with respect to the number of necessary resources calculated by a resource number calculation equation, based on the number of effective resources calculated by an effective resource number determination equation.

### CITATION LIST

### Patent Literature

[PTL 1] Japanese Patent Application Laid-Open Publication No. 2010-146420
[PTL 2] Japanese Patent Application Laid-Open Publication No. 2009-199395
[PTL 3] Japanese Patent Application Laid-Open Publication No. 2011-013822
[PTL 4] Japanese Patent Application Laid-Open Publication No. 2009-181578
[PTL 5] WO 2010/044131
[PTL 6] Japanese Patent Application Laid-Open Publication No. 2005-173928

### Non Patent Literature

[NPL 1] “IBM PureFlex System (a registered trademark)”, International Business Machines Corporation, [online], [searched on Dec. 3, 2012], the Internet <URL: http://www-06.ibm.com/systems/jp/pureflex/enterprise/>

### SUMMARY OF INVENTION

### Technical Problem

In the techniques disclosed in PTL 1 and PTL 2 described above, it is assumed that all physical resources are virtualized and a system is constructed on a virtualization platform.

However, depending on the system, in view of information management and performance requirements, it is necessary to deploy (install) a part of servers configuring a system not as virtual servers running on virtual machines but as dedicated servers running on physical computers (hardware) dedicated to the servers.

Further, even in an on-premises environment, it is not always possible to provide a sufficient number of computers and resources thereof. Therefore, in some cases, there exists a constraint such that, in consideration of facilities and running cost, a system is constructed using a minimum number of computers or using existing surplus computers. In this case, it is not always possible to provide computers to deploy all servers configuring the system as dedicated servers and therefore, it is necessary to deploy servers having a lower degree of importance as virtual servers.

The techniques disclosed in PTL 1 and PTL 2 described above do not consider that, for a system in which dedicated servers and virtual servers are mixed, resources are allocated and the system is constructed.

An object of the present invention is to provide a system construction device and a system construction method capable of solving the above problems and of efficiently constructing a system in which dedicated servers and virtual servers are mixed.

### Solution to Problem

A system construction device according to an exemplary aspect of the invention includes: a configuration information acquiring means for acquiring system configuration information including, for each of one or more servers included in a system, a resource condition indicating a condition for a resource of a processing device needed by the server and a dedicated condition indicating whether the server is deployed as a dedicated server to which a processing device is dedicated; a resource information acquiring means for acquiring resource information including, for each of one or more processing devices, information on a resource of the processing device; and an allocation means for performing an allocation process which allocates, to a server to be deployed as a dedicated server among the one or more servers included in the system, a processing device having a resource matching the resource condition of the server to be deployed as a dedicated server among the one or more processing devices, and allocates, to a server not to be deployed as a dedicated server among the one or more servers included in the system, a resource matching the resource condition of the server not to be deployed as a dedicated server and being on a processing device not allocated to the server to be deployed as a dedicated server among the one or more processing devices as a resource for deploying the server as a virtual server, referring to the system configuration information and the resource information.

A system construction method according to an exemplary aspect of the invention includes: acquiring system configuration information including, for each of one or more servers included in a system, a resource condition indicating a condition for a resource of a processing device needed by the server and a dedicated condition indicating whether the server is deployed as a dedicated server to which a processing device is dedicated; acquiring resource information including, for each of one or more processing devices, information on a resource of the processing device; and performing an allocation process which allocates, to a server to be deployed as a dedicated server among the one or more servers included in the system, a processing device having a resource matching the resource condition of the server to be deployed as a dedicated server among the one or more processing devices, and allocates, to a server not to be deployed as a dedicated server among the one or more servers included in the system, a resource matching the resource condition of the server not to be deployed as a dedicated server and being on a processing device not allocated to the server to be deployed as a dedicated server among the one or more processing devices as a resource for deploying the server as a virtual server, referring to the system configuration information and the resource information.

A computer readable storage medium according to an exemplary aspect of the invention records thereon a program, causing a computer to perform a method comprising: acquiring system configuration information including, for each of one or more servers included in a system, a resource condition indicating a condition for a resource of a processing device needed by the server and a dedicated condition indicating whether the server is deployed as a dedicated server to which a processing device is dedicated; acquiring resource information including, for each of one or more processing devices, information on a resource of the processing device; and performing an allocation process which allocates, to a server to be deployed as a dedicated server among the one or more servers included in the system, a processing device having a resource matching the resource condition of the server to be deployed as a dedicated server among the one or more processing devices, and allocates, to a server not to be deployed as a dedicated server among the one or more servers included in the system, a resource matching the resource condition of the server not to be deployed as a dedicated server and being on a processing device not allocated to the server to be deployed as a dedicated server among the one or more processing devices as a resource for deploying the server as a virtual server, referring to the system configuration information and the resource information.

### Advantageous Effects of Invention

An advantageous effect of the present invention is that it is possible to efficiently construct a system in which dedicated servers and virtual servers are mixed.

### BRIEF DESCRIPTION OF DRAWINGS

FIG. 1 is a block diagram illustrating a characteristic configuration of a first exemplary embodiment of the present invention.

FIG. 2 is a block diagram illustrating a configuration of a system construction device 100 in the first exemplary embodiment of the present invention.

FIG. 3 is a diagram illustrating an example of system configuration information 501 in the first exemplary embodiment of the present invention.

FIG. 4 is a chart illustrating an example of resource requirement information 511 in the first exemplary embodiment of the present invention.

FIG. 5 is a chart illustrating an example of resource information 601 in the first exemplary embodiment of the present invention.

FIG. 6 is a chart illustrating an example of an allocation result 701 in the first exemplary embodiment of the present invention.

FIG. 7 is a flowchart illustrating processing of the system construction device 100 in the first exemplary embodiment of the present invention.

FIG. 8 is a flowchart illustrating details of an allocation process (step S103) in the first exemplary embodiment of the present invention.

FIG. 9 is a diagram illustrating an example of system configuration information 501 in a second exemplary embodiment of the present invention.

FIG. 10 is a flowchart illustrating details of an allocation process (step S103) in a third exemplary embodiment of the present invention.

FIG. 11 is a chart illustrating an example of resource requirement information 511 in a fourth exemplary embodiment of the present invention.

FIG. 12 is a flowchart illustrating details of an allocation process (step S103) in the fourth exemplary embodiment of the present invention.

### DESCRIPTION OF EMBODIMENTS

### First Exemplary Embodiment

Next, a first exemplary embodiment of the present invention will be described.

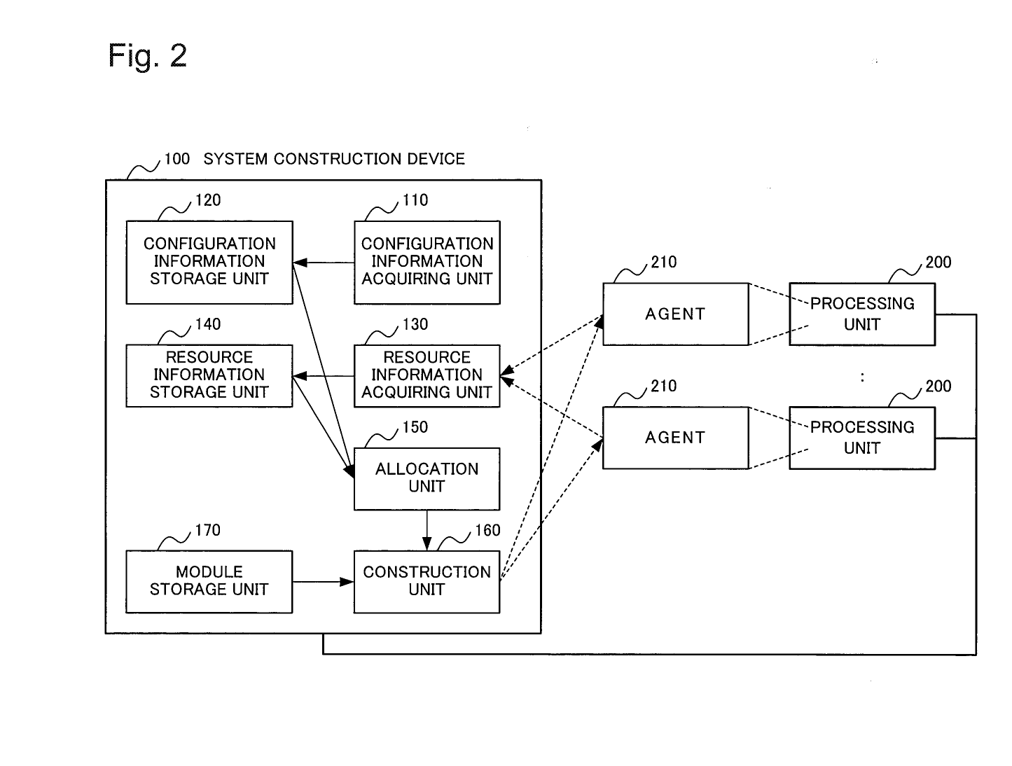

Initially, a configuration of the first exemplary embodiment of the present invention will be described. FIG. 2 is a block diagram illustrating a configuration of a system construction device 100 in the first exemplary embodiment of the present invention.

Referring to FIG. 2, the system construction device 100 of the first exemplary embodiment of the present invention is connected to a plurality of processing devices 200 included in a system construction target environment, via a network or the like. The processing device 200 is a physical computer including, for example, a fundamental OS (Operating System) including a communication function and an install program.

In the first exemplary embodiment of the present invention, a system includes a plurality of servers as components. Each server includes one or more program modules (hereinafter, referred to as modules) such as an OS, middleware, an application, and the like, as components.

The server is deployed (or installed) as a dedicated server running on the processing device 200 dedicated to the server or alternatively, as a virtual server running on a virtual machine. The virtual server is constructed on a virtualization platform of the processing device 200 shared with other servers. The virtualization platform is, for example, a VM (Virtual Machine) monitor or a hypervisor, and generates and manages a virtual machine.

When a server is deployed as a dedicated server, the processing device 200 in a system construction target environment is allocated to the server. Each module configuring the server is deployed (installed) in the allocated processing device 200 and thereby, the server is deployed. All of the modules configuring the server may be deployed using a disk image. Further, it is possible that a part of the modules such as an OS and the like configuring the server are deployed using a disk image and the higher modules are deployed in a sequential order.

When a server is deployed as a virtual server, a resource on the processing device 200 which is not allocated to a server deployed as a dedicated server in the system construction target environment is allocated to the server, and a virtual machine is constructed using the allocated resource. Each module configuring the server is deployed (installed) in the constructed virtual machine to deploy the server. All of the modules configuring the server may be deployed using a virtual image. Further, it is possible that a part of the modules such as an OS and the like configuring the server are deployed using a virtual image and the higher modules are deployed in a sequential order.

In this manner, each server configuring a system is deployed as a dedicated server or a virtual server to construct the system.

The system construction device 100 includes a configuration information acquiring unit 110, a configuration information storage unit 120, a resource information acquiring unit 130, a resource information storage unit 140, an allocation unit 150, a construction unit 160, and a module storage unit 170.

The configuration information acquiring unit 110 acquires system configuration information 501 from an administrator or the like. The system configuration information 501 indicates a required condition for a resource of each server configuring a system to be a constructed and information on a module configuring each server.

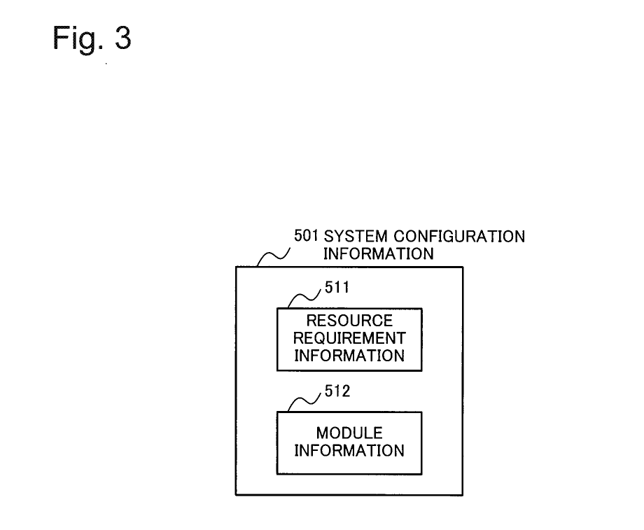

FIG. 3 is a diagram illustrating an example of the system configuration information 501 in the first exemplary embodiment of the present invention. The system configuration information 501 includes resource requirement information 511 and module information 512.

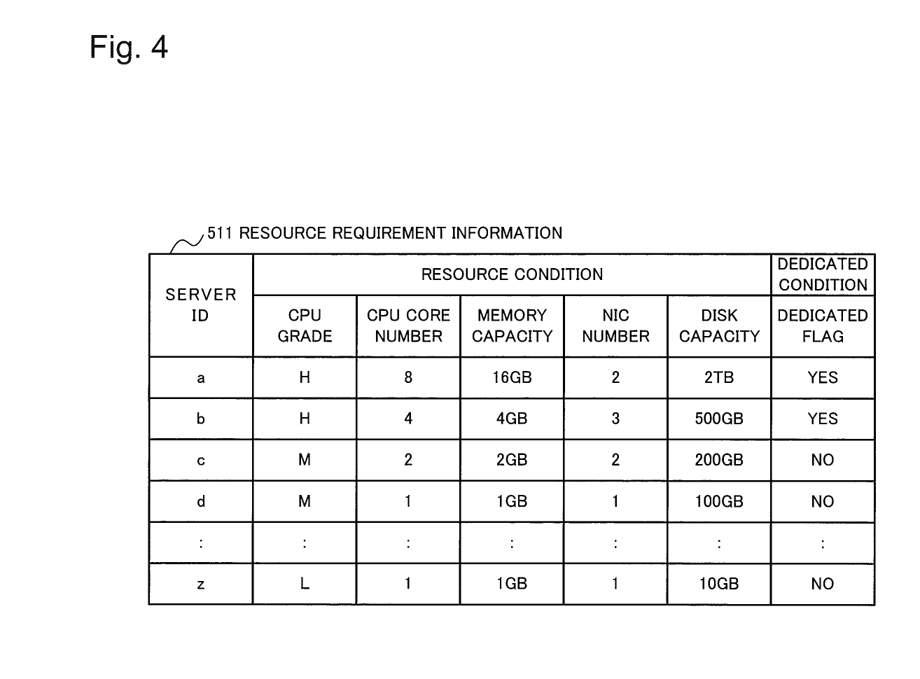

FIG. 4 is a chart illustrating an example of the resource requirement information 511 in the first exemplary embodiment of the present invention. The resource requirement information 511 includes an identifier of each server (server ID (identifier)), a resource condition and a dedicated condition as a required condition for a resource of the server. The resource condition includes a grade of a CPU (Central Processing Unit) (a CPU grade), the number of cores in the CPU (a CPU core number), a capacity of a memory (a memory capacity), the number of network interface cards (an NIC number), and a hard disk capacity (a disk capacity), needed by the server. The dedicated condition includes a dedicated flag. The dedicated flag indicates whether the server is deployed as a dedicated server (YES) or not (NO). The resource requirement information 511 may include the necessary number of the server.

The module information 512 (not illustrated) includes an identifier of a module configuring each server and setting for the module.

The configuration information storage unit 120 stores the acquired system configuration information 501.

The resource information acquiring unit 130 acquires resource information 601 from the processing device 200. The resource information 601 indicates information on a resource allocatable by each processing unit 200 in the system construction target environment.

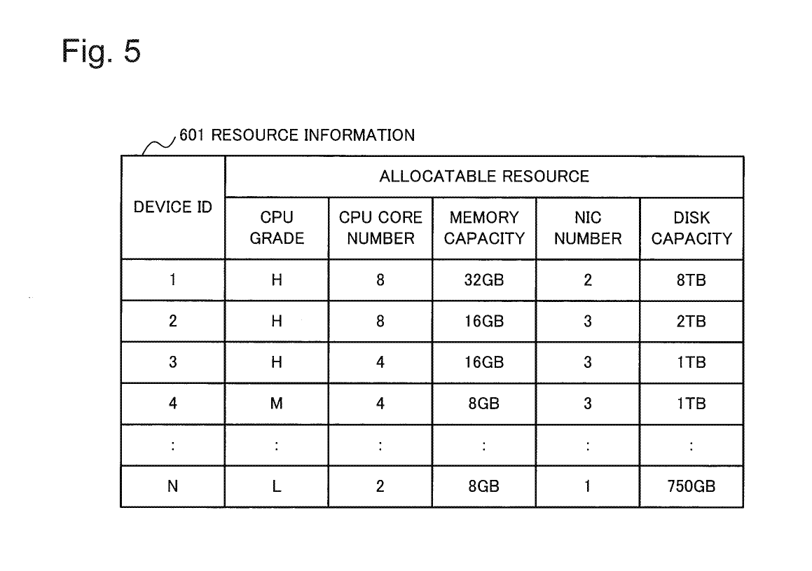

FIG. 5 is a chart illustrating an example of the resource information 601 in the first exemplary embodiment of the present invention. The resource information 601 includes an identifier of each processing device 200 (a device ID) and a resource allocatable to a server by the processing device 200. The allocatable resource includes a grade of a CPU (a CPU grade), the number of cores in the CPU (a CPU core number), a capacity of a memory (a memory capacity), the number of network interface cards (an NIC number), and a hard disk capacity (a disk capacity). The resource information 601 may include the number of the processing devices 200.

The resource information acquiring unit 130 may acquire the resource information 601 via an agent 210 included in each processing device 200. The agent 210 may be manually deployed in each processing device 200 by the administrator or the like. Further, the agent 210 may be automatically deployed in each processing device 200, using a tool such as Tivoli Provisioning Manager for Operating System Deployment (http://www-06.ibm.com/software/jp/tivoli/products/prov-mgr-os-deploy/). Further, the agent 210 may be deployed in each processing device 200 by booting, via network boot, the each processing device 200 using an OS in which the agent 210 is embedded.

The resource information storage unit 140 stores the acquired resource information 601.

The allocation unit 150 allocates the processing device 200 or a resource on the processing device 200 to each server configuring the system, based on the resource requirement information 511 and the resource information 601 (performing matching between the configuration of the system and the system construction target environment).

The construction unit 160 deploys, in the processing device 200 allocated to each server or a virtual machine constructed using the resource on the processing device 200 allocated to each server, each module configuring the server, based on the module information 512. The construction unit 160 acquires each module from the module storage unit 170 and deploys the acquired module.

The module storage unit 170 stores modules such as an OS, middleware, an application, and the like used for configuring a server.

The system construction device 100 may be a computer including a CPU and a storage medium stored with a program, and operates under the control based on the program. The configuration information storage unit 120, the resource information storage unit 140, and the module storage unit 170 may be individual storage media or may be configured using a single storage medium.

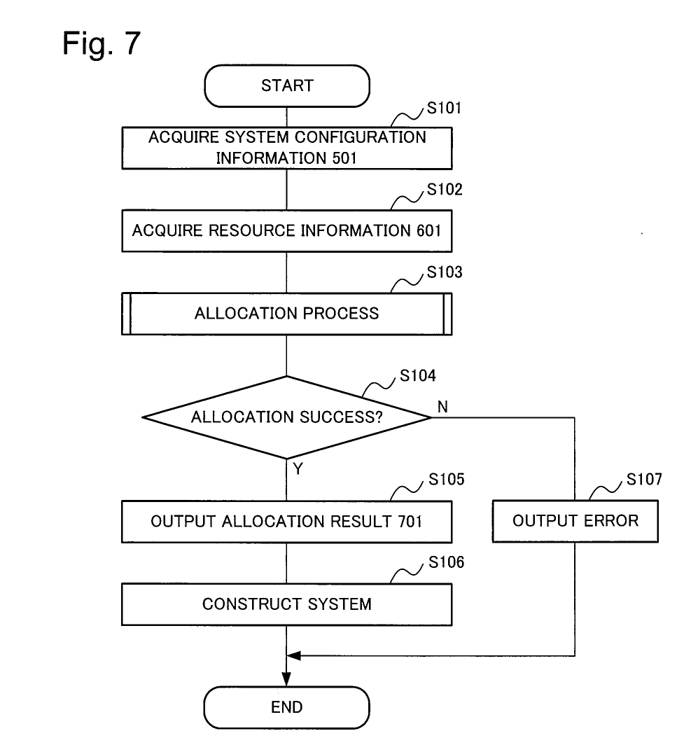

Next, an operation of the first exemplary embodiment of the present invention will be described. FIG. 7 is a flowchart illustrating processing of the system construction device 100 in the first exemplary embodiment of the present invention.

The configuration information acquiring unit 110 of the system construction device 100 acquires system configuration information 501 of a system to be constructed from an administrator or the like (step S101). The configuration information acquiring unit 110 stores the acquired system configuration information 501 on the configuration information storage unit 120.

For example, the configuration information acquiring unit 110 acquires the system configuration information 501 including the resource requirement information 511 of FIG. 4.

The resource information acquiring unit 130 acquires resource information 601 from the processing device 200 in a system construction target environment (step S102). The resource information acquiring unit 130 stores the acquired resource information 601 on the resource information storage unit 140.

For example, the resource information acquiring unit 130 acquires the resource information 601 of FIG. 5.

The allocation unit 150 performs an “allocation process” described later to allocate a processing device 200 to a server to be deployed as a dedicated server and allocate a resource on a processing device 200 to a server other than the server to be deployed as a dedicated server (step S103).

When a processing result of the “allocation process” is “allocation success” (step S104/Y), the allocation unit 150 generates an allocation result 701 and outputs the result to the administrator or the like (step S105).

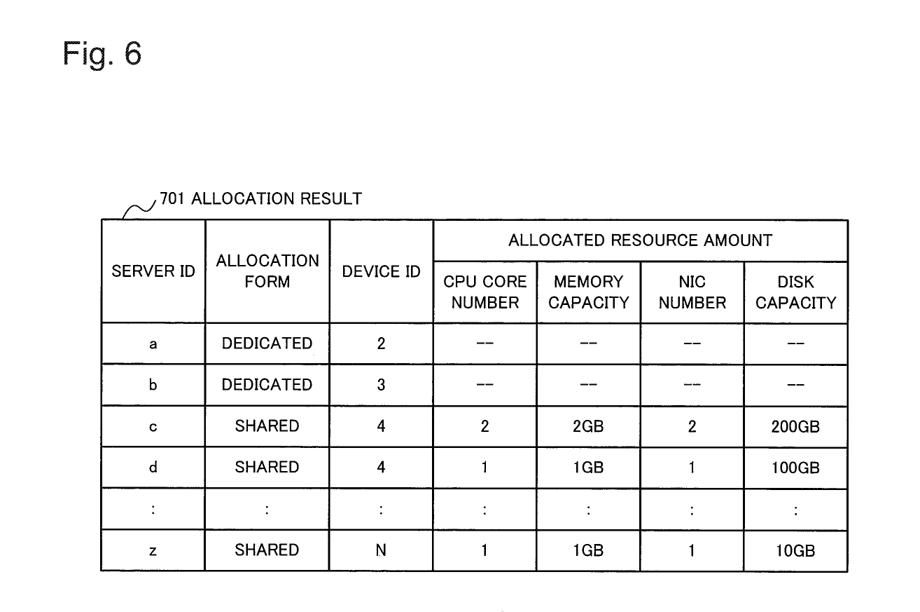

FIG. 6 is a chart illustrating an example of the allocation result 701 in the first exemplary embodiment of the present invention. The allocation result 701 includes a server ID of a server, an allocation form of the processing device 200 for the server, a device ID of the processing device 200 allocated to the server, and a resource amount allocated to the server (allocated resource amount). The allocation form indicates whether the processing device 200 is dedicated to a server (the server being deployed as a dedicated server) (dedicated) or a server shares the processing device 200 with another server (the server being deployed as a virtual server) (shared). The allocation resource amount (CPU core number, memory capacity, and disk capacity) is set when the allocation form is “shared.”

For example, the allocation unit 150 generates the allocation result 701 of FIG. 6.

The construction unit 160 constructs the system using the allocated processing devices 200 or the resource on the processing devices 200 indicated by the allocation result 701, according to an instruction from the administrator or the like (step S106). The construction unit 160 refers to the module information 512 and deploys each module of each server configuring the system. The construction unit 160 deploys, for a server to be deployed as a dedicated server, each module configuring the server in the allocated processing device 200. Further, the construction unit 160 deploys, for a server to be deployed as a virtual server, a virtualization platform in the processing device 200 including the allocated resource. Then, the construction unit 160 constructs a virtual machine on the deployed virtualization platform using the allocated resource and deploys each module configuring the server in the constructed virtual machine.

For example, the construction unit 160 deploys servers “a” and “b” in the processing devices 200 “2” and “3” as dedicated servers, respectively, based on the allocation result 701 of FIG. 6. Further, the construction unit 160 deploys servers “c” and “d” in the processing device 200 “4” as virtual servers.

On the other hand, when the processing result of the “allocation process” is “allocation failure” (step S104/N), the allocation unit 150 outputs an “error” to the administrator or the like (step S107) and then the processing ends.

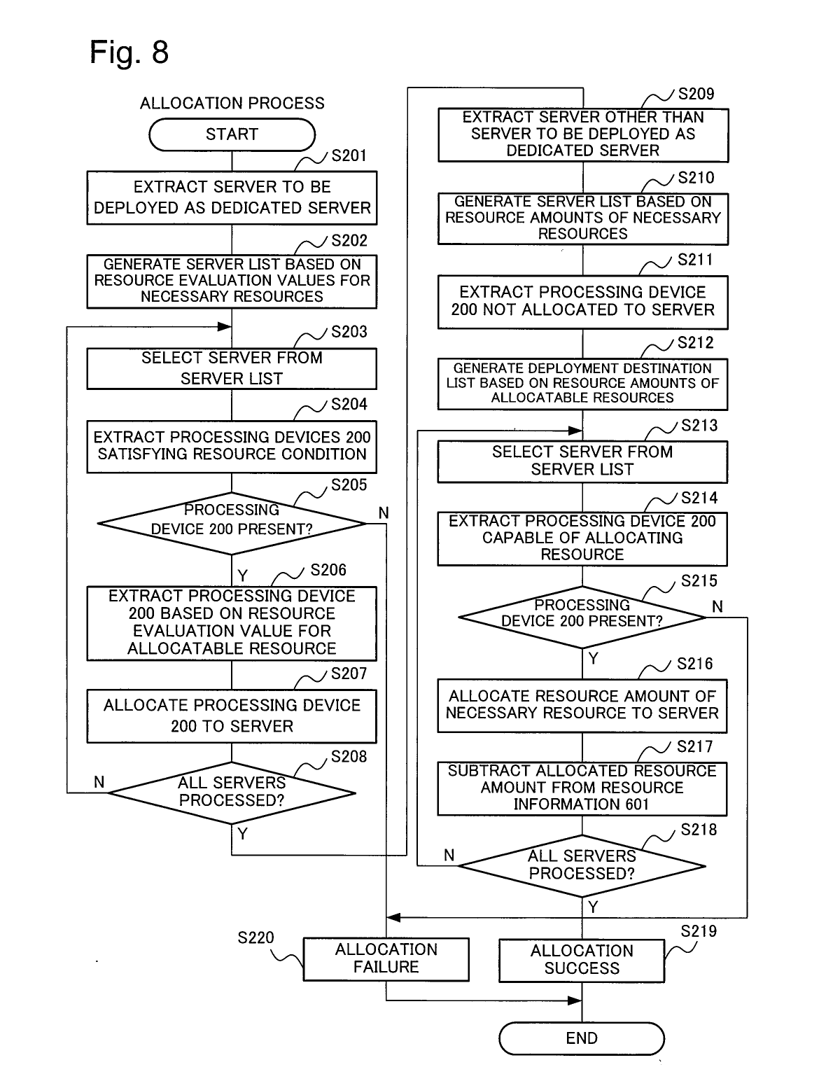

Next, details of the allocation process (step S103) will be described. FIG. 8 is a flowchart illustrating details of the allocation process (step S103) in the first exemplary embodiment of the present invention.

Initially, the allocation unit 150 extracts a server ID of a server to be deployed as a dedicated server from the resource requirement information 511 (step S201). The allocation unit 150 extracts a server having a dedicated flag of “YES” in the dedicated condition of the resource requirement information 511.

For example, the allocation unit 150 extracts servers “a” and “b” from the resource requirement information 511 of FIG. 4.

The allocation unit 150 calculates, for each server extracted in step S201, a resource evaluation value for a necessary resource of the server and generates a server list in which server IDs are disposed in decreasing order of resource evaluation values (step S202). The resource evaluation value represents a magnitude of an entire resource amount. The allocation unit 150 calculates the resource evaluation value for a necessary resource, for example, using a resource evaluation equation represented as Math. 1.

(Resource evaluation value)=P×CN×Bₚ+M×Bₘ+N×Bₙ+D×B_{d} [Math. 1]

P (a value corresponding to a CPU grade) H: 100, M: 60, L: 30

CN (CPU core number)

M (normalized memory capacity):
memory capacity/maximum required memory capacity×100

N (normalized NIC number):
NIC number/maximum required NIC number×100

D (normalized disk capacity):
disk capacity/maximum required disk capacity×100

Bₚ, Bₘ, Bₙ, B_{d} (resource weights)

It is assumed that the resource evaluation equation, and the parameters in the resource evaluation equation (the maximum required memory capacity, the maximum required disk capacity, and the weights of the respective resources Bₚ, Bₘ, Bₙ, and B_{d} in equation Math. 1) are previously set in the system construction device 100 by the administrator or the like.

The allocation unit 150 selects a server in order from the top of the server list generated in step S202 (step S203).

The allocation unit 150 extracts all device IDs of processing devices 200 satisfying a resource condition of the server selected in step S203 in the resource requirement information 511 (step S204). Here, the allocation unit 150 extracts device IDs from processing devices 200 which are included in the resource information 601 and not allocated to other servers. The allocation unit 150 refers to the resource information 601 and extracts processing devices 200 satisfying both of the following two conditions. A first condition is that “an allocatable CPU grade is equal to or greater than a CPU grade indicated by the resource condition.” A second condition is that “an allocatable CPU core number, memory capacity, and disk capacity are equal to or greater than a CPU core number, a memory capacity, and a disk capacity indicated by the resource condition, respectively.”

When processing devices 200 satisfying the resource condition are present in step S204 (step S205/Y), the allocation unit 150 calculates a resource evaluation value for an allocatable resource of each processing device 200 extracted in step S204. Then, the allocation unit 150 extracts the processing device 200 having the minimum value of the calculated resource evaluation value (step S206). Here, the allocation unit 150 calculates a resource evaluation value for an allocatable resource of each processing device 200 using the resource evaluation equation represented by equation Math. 1 in the same manner as step S202.

The allocation unit 150 allocates the extracted processing device 200 to the server (step S207). The allocation unit 150 sets the device ID of the allocated processing device 200 in the allocation result 701.

The allocation unit 150 repeats steps S203 to S207 for all the servers included in the server list generated in step S202 (step S208).

For example, the allocation unit 150 allocates processing devices 200 “2” and “3” to the servers “a” and “b,” respectively, as in the allocation result 701 of FIG. 6.

The allocation unit 150 extracts a server ID of a server other than the servers to be deployed as dedicated servers (a server to be deployed as a virtual server) from the resource requirement information 511 (step S209). Here, the allocation unit 150 extracts a server ID having a dedicated flag of “NO” in the dedicated condition of the resource requirement information 511.

For example, the allocation unit 150 extracts servers “c” and “d” from the resource requirement information 511 of FIG. 4.

The allocation unit 150 generates a server list in which server IDs of respective servers extracted in step S209 are disposed in order from a higher grade and larger resource amount (higher CPU grade and larger CPU core number) of a necessary resource (step S210).

The allocation unit 150 extracts all device IDs of processing devices 200 which are not allocated to servers from the resource information 601 (step 211).

The allocation unit 150 generates a deployment destination list in which the device IDs of the processing devices 200 extracted in step S211 are disposed in order from a lower grade and smaller resource amount (lower CPU grade and smaller CPU core number) of an allocatable resource (step S212).

The allocation unit 150 selects a server in order from the top of the server list generated in step S210 (step S213).

The allocation unit 150 searches and extracts a processing device 200 capable of allocating a resource satisfying a resource condition of the server selected in step S213 in the resource requirement information 511, from the processing device 200 of the top of the deployment destination list (step S214). The allocation unit 150 refers to the resource information 601 and extracts a processing device 200 satisfying both of the following two conditions. A first condition is that “an allocatable CPU grade is equal to or greater than a CPU grade indicated by the resource condition.” A second condition is that “an allocatable CPU core number, memory capacity, and disk capacity are equal to or greater than a CPU core number, a memory capacity, and a disk capacity indicated by the resource condition, respectively.”

When a processing device 200 capable of allocating a resource is present in step S214 (step S215/Y), the allocation unit 150 allocates a resource of a resource amount indicated by the resource condition from the resource in the processing device 200 to the server (step S216). The allocation unit 150 sets the device ID of the processing device 200 from which the resource is allocated and the resource amount in the allocation result 701.

The allocation unit 150 subtracts the resource amount allocated in step S216 from the allocatable resource amount (a CPU core number, a memory capacity, and a disk capacity) of the processing device 200 from which the resource is allocated, in the resource information 601 (step S217).

The allocation unit 150 repeats steps S213 to S217 for all the servers included in the server list generated in step S210 (step S218).

For example, the allocation unit 150 allocates a resource of processing device 200 “4” to servers “c” and “d” as in the allocation result 701 of FIG. 6.

The allocation unit 150 sets “allocation success” as a processing result (step S219) and then the processing ends.

On the other hand, when in step S204, a processing device 200 satisfying the resource condition is not present (step 205/N), the allocation unit 150 sets “allocation failure” as a processing result (step S220) and then the processing ends. Also when in step S214, a processing device 200 capable of allocating a resource is not present (step S215/N), the allocation unit 150 sets “allocation failure” as a processing result (step S220) and then the processing ends.

As described above, the operation of the first exemplary embodiment of the present invention is completed.

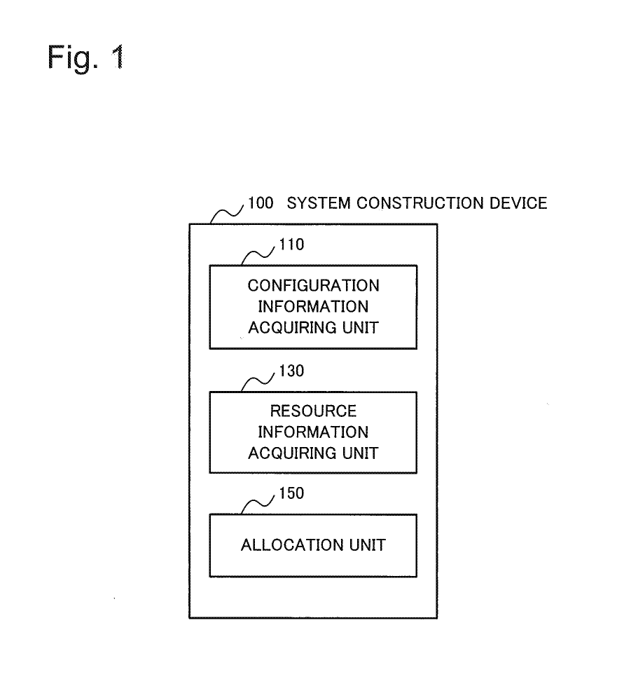

Next, a characteristic configuration of the first exemplary embodiment of the present invention will be described. FIG. 1 is a block diagram illustrating a characteristic configuration of the first exemplary embodiment of the present invention.

Referring to FIG. 1, a system construction device 100 includes a configuration information acquiring unit 110, a resource information acquiring unit 130, and an allocation unit 150.

The configuration information acquiring unit 110 acquires system configuration information 501. The system configuration information 501 includes, for each of one or more servers included in a system, a resource condition and a dedicated condition. The resource condition indicates a condition for a resource of a processing device 200 needed by the server. The dedicated condition indicates whether the server is deployed as a dedicated server to which a processing device 200 is dedicated.

The resource information acquiring unit 130 acquires resource information 601. The resource information 601 includes, for each of one or more processing devices 200, information on a resource of the processing device 200.

The allocation unit 150 performs an allocation process referring to the system configuration information 501 and the resource information 601. In the allocation process, the allocation unit 150 allocates, to a server to be deployed as a dedicated server among the one or more servers included in the system, a processing device 200 having a resource matching the resource condition of the server to be deployed as a dedicated server among the one or more processing devices 200. In the allocation process, the allocation unit 150 allocates, to a server not to be deployed as a dedicated server among the one or more servers included in the system, a resource being on a processing device 200 not allocated to the server to be deployed as a dedicated server among the one or more processing devices 200. Here, the allocation unit 150 allocates a resource matching the resource condition of the server not to be deployed as a dedicated server as a resource for deploying the server as a virtual server.

According to the first exemplary embodiment of the present invention, it is possible to efficiently construct a system in which dedicated servers and virtual servers are mixed.

The reason is that the allocation unit 150 allocates a resource to a server configuring a system based on the system configuration information 501 including a resource condition and a dedicated condition of the system and the resource information 601 acquired from a system construction target environment, as described below. When the server configuring the system is a server to be deployed as a dedicated server, the allocation unit 150 allocates a processing device 200 including a resource matching the resource condition to the server. When the server configuring the system is not a server to be deployed as a dedicated server, the allocation unit 150 allocates a resource on a processing device 200 which is not allocated to the server to be deployed as a dedicated server to the server. In this case, the allocation unit 150 allocates a resource matching the resource condition on the processing device 200 as a resource for deploying the server as a virtual server.

Further, according to the first exemplary embodiment of the present invention, it is possible to efficiently construct systems corresponding to the same system configuration information 501 in a plurality of different environments.

The reason is that as described above, on the basis of the system configuration information 501 and the resource information 601, the allocation unit 150 determines a processing device 200 or a resource to be allocated to each server configuring the system. This makes it possible to repeatedly apply the same system configuration information 501 to different environments without preparing configuration information and system construction procedures according to the system construction target environment.

Further, according to the first exemplary embodiment of the present invention, it is possible to construct a system even when an ample number of the processing devices 200 are not present in the system construction target environment.

The reason is that the allocation unit 150 allocates a resource for deploying a server as a virtual server to the server other than a server to be deployed as a dedicated server. This makes it possible to deploy as many servers as possible as virtual servers in each environment and construct a larger number of systems.

### Second Exemplary Embodiment

Next, a second exemplary embodiment of the present invention will be described.

The second exemplary embodiment of the present invention is different from the first exemplary embodiment of the present invention in that a resource evaluation equation is designated for each system.

A configuration of the second exemplary embodiment of the present invention is the same as that of the first exemplary embodiment of the present invention.

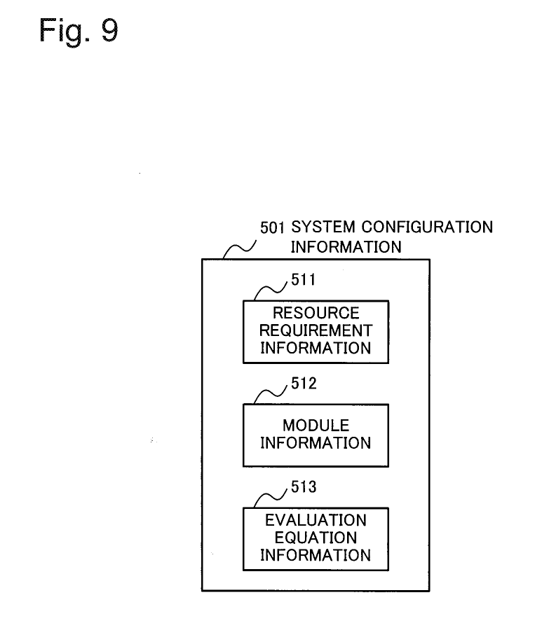

FIG. 9 is a diagram illustrating an example of the system configuration information 501 in the second exemplary embodiment of the present invention. The system configuration information 501 includes evaluation equation information 513 in addition to the resource requirement information 511 and the module information 512.

The evaluation equation information 513 includes a resource evaluation equation applied to a system of the system configuration information 501. In the evaluation equation information 513, parameters (e.g., weights of the respective resources Bₚ, Bₘ, Bₙ, and B_{d} in equation Math. 1) in the resource evaluation equation may be designated.

Next, an operation of the second exemplary embodiment of the present invention will be described.

The operation of the second exemplary embodiment of the present invention is the same as that of the first exemplary embodiment of the present invention except steps S202 and S206.

In step S202 and S206, using a resource evaluation equation designated by the evaluation equation information 513, the allocation unit 150 calculates a resource evaluation value for a necessary resource of a server and a resource evaluation value for an allocatable resource of each processing device 200.

According to the second exemplary embodiment of the present invention, it is possible to allocate a processing device 200 or a resource suitable for characteristics of a system to be constructed. The reason is that the allocation unit 150 calculates a resource evaluation value using the resource evaluation equation designated by the evaluation equation information 513.

### Third Exemplary Embodiment

Next, a third exemplary embodiment of the present invention will be described.

The third exemplary embodiment of the present invention is different from the first exemplary embodiment of the present invention in that, as the resource evaluation equation, a plurality of evaluation equations are used.

A configuration of the third exemplary embodiment of the present invention is the same as that of the first exemplary embodiment of the present invention.

In the third exemplary embodiment of the present invention, the resource evaluation equation set in the system construction device 100 is a list of a plurality of evaluation equations.

Next, an operation of the third exemplary embodiment of the present invention will be described.

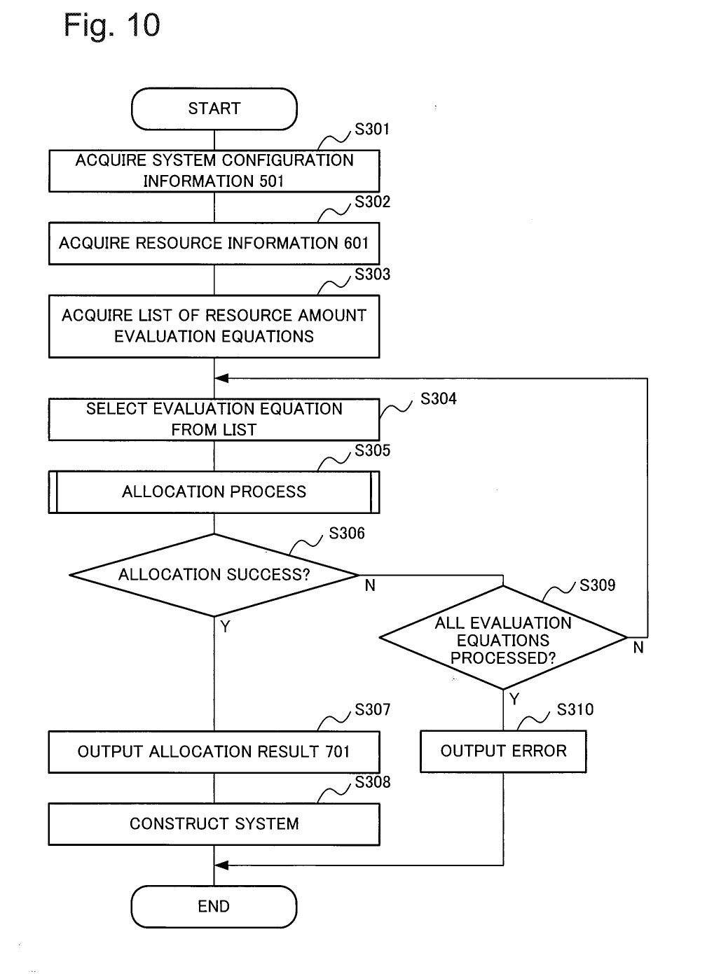

FIG. 10 is a flowchart illustrating processing of the system construction device 100 in the third exemplary embodiment of the present invention.

Initially, in the same manner as in the first exemplary embodiment (steps S101 and S102) of the present invention, the configuration information acquiring unit 110 acquires the system configuration information 501 (step S301), and the configuration information acquiring unit 110 acquires the resource information 601 (step S302).

The allocation unit 150 acquires a list of evaluation equations set in the system construction device 100 as the resource evaluation equation (step S303).

The allocation unit 150 selects an evaluation equation in order from the top of the acquired list (step S304).

The allocation unit 150 performs the above-described “allocation process” (steps S201 to S220), using the selected evaluation equation (step S305).

When a processing result of the “allocation process” is “allocation success” (step S306/Y), the allocation unit 150 outputs the allocation result 701 in the same manner as in the first exemplary embodiment (steps S105 and S106) of the present invention (step S307). Then, the construction unit 160 constructs the system (step S308).

When the processing result of the “allocation process” is “allocation failure” (step S306/N), the allocation unit 150 determines whether the process has been performed for all the evaluation equations included in the list acquired in step S303 (step S309). When the process has been performed for all the evaluation equations (step S309/Y), the allocation unit 150 outputs an “error” in the same manner as in the first exemplary embodiment (step S107) of the present invention (step S310).

When an evaluation equation for which the process has not been performed exists (step S309/N), the allocation unit 150 repeats processes from step S304.

As described above, the operation of the third exemplary embodiment of the present invention is completed.

Note that the third exemplary embodiment of the present invention has described, as an example, a case in which an allocation process using a plurality of evaluation equations is performed in the first exemplary embodiment of the present invention, but the allocation process using a plurality of evaluation equations may be performed in the second exemplary embodiment of the present invention. In this case, the resource evaluation equation included in the evaluation equation information 513 is set as a list of a plurality of evaluation equations.

According to the third exemplary embodiment of the present invention, it is possible to reduce a frequency of failures even when an allocation process fails due to a resource evaluation equation. The reason is that the resource evaluation equation is provided as a list of a plurality of evaluation equations and the allocation unit 150 applies the plurality of evaluation equations in a sequential order to perform an allocation process.

### Fourth Exemplary Embodiment

Next, a fourth exemplary embodiment of the present invention will be described.

The fourth exemplary embodiment of the present invention is different from the first exemplary embodiment of the present invention in that the dedicated condition is designated by dedicated priority.

A configuration of the fourth exemplary embodiment of the present invention is the same as that of the first exemplary embodiment of the present invention.

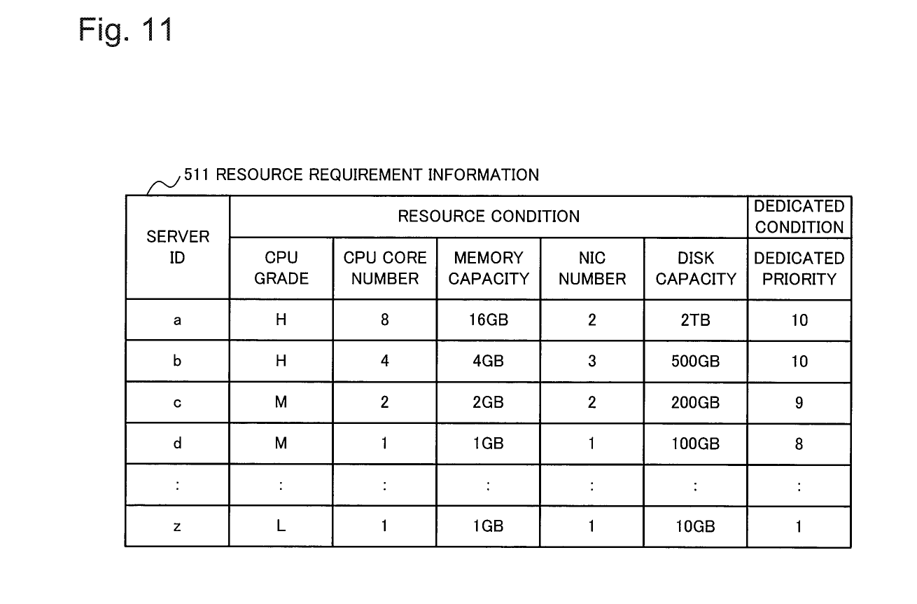

FIG. 11 is a chart illustrating an example of the resource requirement information 511 in the fourth exemplary embodiment of the present invention. In the fourth exemplary embodiment of the present invention, the dedicated condition of the resource requirement information 511 includes a dedicated priority instead of a dedicated flag. The dedicated priority indicates a priority in which the processing device 200 is dedicated to a server. With a larger value of the dedicated priority, a higher priority is indicated.

Next, an operation of the fourth exemplary embodiment of the present invention will be described.

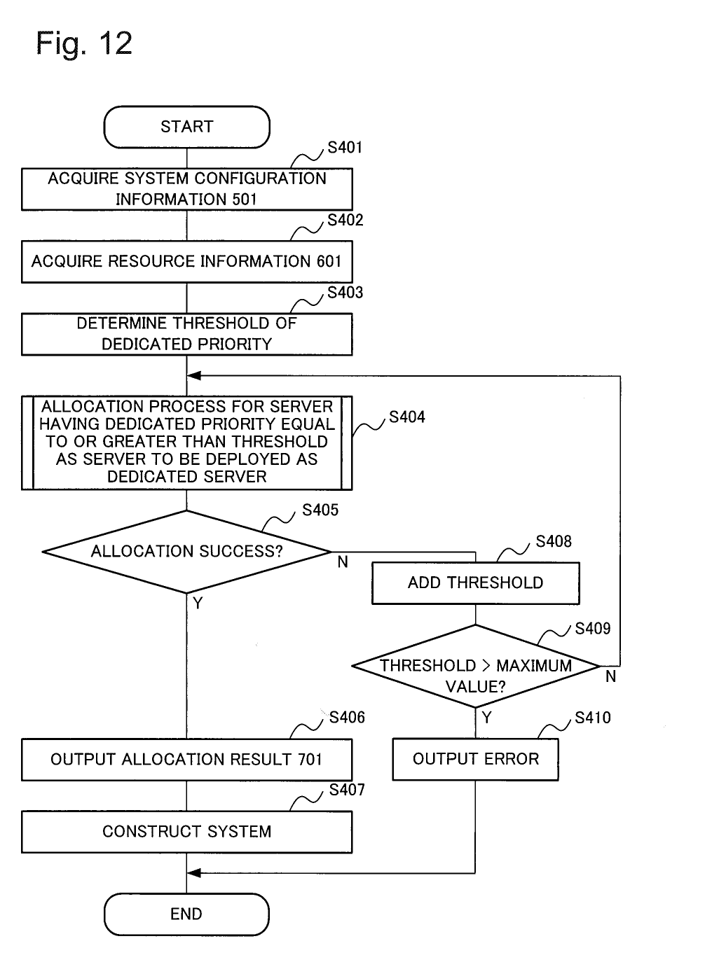

FIG. 12 is a flowchart illustrating processing of the system construction device 100 in the fourth exemplary embodiment of the present invention.

Initially, in the same manner as the first exemplary embodiment (steps S101 and S102) of the present invention, the configuration information acquiring unit 110 acquires the system configuration information 501 (step S401), and the configuration information acquiring unit 110 acquires the resource information 601 (step S402). The allocation unit 150 determines a threshold of the dedicated priority (step S403). Here, the allocation unit 150 determines, for example, a minimum value of dedicated priorities included in the resource requirement information 511 as the threshold.

For example, the allocation unit 150 determines a minimum value “1” of the dedicated priorities in the resource requirement information 511 of FIG. 11 as the threshold.

The allocation unit 150 designates a server having a dedicated priority in the resource requirement information 511 equal to or greater than the threshold determined in step S401 as a server to be deployed as a dedicated server, and performs the above-described “allocation process” (steps S201 to S220) (step S404).

When a processing result of the “allocation process” is “allocation success” (step S405/Y), the allocation unit 150 outputs the allocation result 701 in the same manner as the first exemplary embodiment (steps S105 and S106) of the present invention (step S406). Then, the construction unit 160 constructs the system (step S407).

When the processing result of the “allocation process” is “allocation failure” (step S405/N), the allocation unit 150 adds 1 to the threshold (step S408).

When the threshold is greater than the maximum value of the dedicated priorities included in the resource requirement information 511 (step S409/Y), the allocation unit 150 outputs an “error” in the same manner as the first exemplary embodiment (step S107) of the present invention (step S410).

When the threshold is equal to or smaller the maximum value (step S409/N), the allocation unit 150 repeats processes from step S404.

For example, while increasing the threshold between “1” and “10”, the allocation unit 150 repeats the “allocation process” until “allocation success” is achieved.

As described above, the operation of the fourth exemplary embodiment of the present invention is completed.

Note that the fourth exemplary embodiment of the present invention has described, as an example, a case in which an allocation process using dedicated priority is performed in the first exemplary embodiment of the present invention, but the allocation process using dedicated priority may be performed in the second or third exemplary embodiment of the present invention.

According to the fourth exemplary embodiment of the present invention, it is possible to deploy as many servers as possible among servers configuring a system as dedicated servers according to a system construction target environment. The reason is that the allocation unit 150 designates a server having a dedicated priority equal to or greater than a threshold as a server to be deployed as a dedicated server in an allocation process and performs the allocation process while increasing the threshold.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2012-273755, filed on Dec. 14, 2012, the disclosure of which is incorporated herein in its entirety by reference.

### REFERENCE SIGNS LIST

100 system construction device
110 configuration information acquiring unit
120 configuration information storage unit
130 resource information acquiring unit
140 resource information storage unit
150 allocation unit
160 construction unit
170 module storage unit
200 processing device
210 agent
501 system configuration information
511 resource requirement information
512 module information
513 evaluation equation information
601 resource information
701 allocation result

What is claimed is:

1. A system construction device comprising:
a configuration information acquiring unit which acquires system configuration information including, for each of one or more servers included in a system, a resource condition indicating a condition for a resource of a processing device needed by the server and a dedicated condition indicating whether the server is deployed as a dedicated server to which a processing device is dedicated;
a resource information acquiring unit which acquires resource information including, for each of one or more processing devices, information on a resource of the processing device; and
an allocation unit which performs an allocation process which allocates, to a server to be deployed as a dedicated server among the one or more servers included in the system, a processing device having a resource matching the resource condition of the server to be deployed as a dedicated server among the one or more processing devices, and allocates, to a server not to be deployed as a dedicated server among the one or more servers included in the system, a resource matching the resource condition of the server not to be deployed as a dedicated server and being on a processing device not allocated to the server to be deployed as a dedicated server among the one or more processing devices as a resource for deploying the server as a virtual server, referring to the system configuration information and the resource information.

2. The system construction device according to claim 1, wherein
the allocation unit calculates a resource evaluation value of each of the one or more processing devices using a predetermined resource evaluation equation for calculating a resource evaluation value representing an entire amount of one or more resources, and allocates, to the server to be deployed as a dedicated server, a processing device having a resource evaluation value smaller than a resource evaluation value of other processing devices among processing devices having a resource matching the resource condition of the server to be deployed as a dedicated server and being not allocated.

3. The system construction device according to claim 2, wherein
the system configuration information includes the predetermined resource evaluation equation, and
the allocation unit calculates a resource evaluation value of each of the one or more processing devices using the resource evaluation equation included in the system configuration information.

4. The system construction device according to claim 2, wherein
the predetermined resource evaluation equation includes a plurality of evaluation equations, and
the allocation unit repeats the allocation process using each of the plurality of evaluation equations in a sequential order until a processing device or a resource is completed to be allocated for all of the one or more servers included in the system.

5. The system construction device according to claim 1, wherein
the dedicated condition indicates a priority in which a processing device to be dedicated to the server, and
the allocation unit designates a server having a priority equal to or greater than a threshold as a server to be deployed as a dedicated server and a server having a priority smaller than the threshold as a server not to be deployed as a dedicated server in the allocation process, and repeats the allocation process until a processing device or a resource is completed to be allocated for all of the one or more servers included in the system while increasing the threshold.

6. A system construction method comprising:
acquiring system configuration information including, for each of one or more servers included in a system, a resource condition indicating a condition for a resource of a processing device needed by the server and a dedicated condition indicating whether the server is deployed as a dedicated server to which a processing device is dedicated;
acquiring resource information including, for each of one or more processing devices, information on a resource of the processing device; and
performing an allocation process which allocates, to a server to be deployed as a dedicated server among the one or more servers included in the system, a processing device having a resource matching the resource condition of the server to be deployed as a dedicated server among the one or more processing devices, and allocates, to a server not to be deployed as a dedicated server among the one or more servers included in the system, a resource matching the resource condition of the server not to be deployed as a dedicated server and being on a processing device not allocated to the server to be deployed as a dedicated server among the one or more processing devices as a resource for deploying the server as a virtual server, referring to the system configuration information and the resource information.

7. The system construction method according to claim 6, wherein
the allocation process calculates a resource evaluation value of each of the one or more processing devices using a predetermined resource evaluation equation for calculating a resource evaluation value representing an entire amount of one or more resources, and allocates, to the server to be deployed as a dedicated server, a processing device having a resource evaluation value smaller than a resource evaluation value of other processing devices among processing devices having a resource matching the resource condition of the server to be deployed as a dedicated server and being not allocated.

8. The system construction method according to claim 7, wherein
the predetermined resource evaluation equation includes a plurality of evaluation equations, and
the allocation process is repeated, using each of the plurality of evaluation equations in a sequential order, until a processing device or a resource is completed to be allocated for all of the one or more servers included in the system.

9. The system construction method according to claim 6, wherein
the dedicated condition indicates a priority in which a processing device to be dedicated to the server, and
the allocation process, in which a server having a priority equal to or greater than a threshold is designated as a server to be deployed as a dedicated server and a server having a priority smaller than the threshold is designated as a server not to be deployed as a dedicated server, is repeated, increasing the threshold, until a processing device or a resource is completed to be allocated for all of the one or more servers included in the system.

10. A non-transitory computer readable storage medium recording thereon a program, causing a computer to perform a method comprising:
acquiring system configuration information including, for each of one or more servers included in a system, a resource condition indicating a condition for a resource of a processing device needed by the server and a dedicated condition indicating whether the server is deployed as a dedicated server to which a processing device is dedicated;
acquiring resource information including, for each of one or more processing devices, information on a resource of the processing device; and
performing an allocation process which allocates, to a server to be deployed as a dedicated server among the one or more servers included in the system, a processing device having a resource matching the resource condition of the server to be deployed as a dedicated server among the one or more processing devices, and allocates, to a server not to be deployed as a dedicated server among the one or more servers included in the system, a resource matching the resource condition of the server not to be deployed as a dedicated server and being on a processing device not allocated to the server to be deployed as a dedicated server among the one or more processing devices as a resource for deploying the server as a virtual server, referring to the system configuration information and the resource information.

11. A system construction device comprising:
a configuration information acquiring means for acquiring system configuration information including, for each of one or more servers included in a system, a resource condition indicating a condition for a resource of a processing device needed by the server and a dedicated condition indicating whether the server is deployed as a dedicated server to which a processing device is dedicated;
a resource information acquiring means for acquiring resource information including, for each of one or more processing devices, information on a resource of the processing device; and
an allocation means for performing an allocation process which allocates, to a server to be deployed as a dedicated server among the one or more servers included in the system, a processing device having a resource matching the resource condition of the server to be deployed as a dedicated server among the one or more processing devices, and allocates, to a server not to be deployed as a dedicated server among the one or more servers included in the system, a resource matching the resource condition of the server not to be deployed as a dedicated server and being on a processing device not allocated to the server to be deployed as a dedicated server among the one or more processing devices as a resource for deploying the server as a virtual server, referring to the system configuration information and the resource information.
